(19) United States
(12) Patent Application Publication
(10) Pub. No.: US 2016/0345620 A1
(43) Pub. Date: Dec. 1, 2016

(54) Coffee Bean Roaster

(71) Applicant: Aillio Limited, Taipei (TW)

(72) Inventor: Jonas Lillie, Taipei (TW)

(21) Appl. No.: 14/726,656

(22) Filed: Jun. 1, 2015

(51) Int. Cl. A23N 12/08; H05B 6/12

(52) U.S. Cl. CPC A23N 12/08; H05B 6/12; H05B 2206/02

(57) ABSTRACT

A coffee bean roaster includes a metal drum, an insulation board, and a coil. The insulation board is attached to a portion of the metal drum. The coil is disposed below the insulation board. AC power is supplied to the coil to thereby enable the coil to produce an AC magnetic field. The metal drum is heated up by electromagnetic induction to thereby roast coffee beans in the metal drum.

### BACKGROUND OF THE INVENTION

Field of the Invention

The present invention relates to coffee bean roasters and more particularly to a family-style small-sized coffee bean roaster.

Description of the Prior Art

A conventional coffee bean roaster works by heating and roasting green coffee beans to produce the characteristic flavor of coffee. During the roasting process, the green coffee beans are heated up so as to be dehydrated and browned.

In general, the heat source required for the roasting process is traditionally supplied by natural gas or electrical heater; however, the former is poor in temperature control, and the latter is power-consuming.

In view of the drawbacks of the prior art, it is necessary to provide an energy-efficient coffee bean roaster.

### SUMMARY OF THE INVENTION

It is an objective of the present invention to provide a coffee bean roaster and more particularly to a coffee bean roaster which achieves energy efficiency through heating by electromagnetic induction.

In order to achieve the above and other objectives, the present invention provides a coffee bean roaster which comprises a metal drum, an insulation board, and a coil. The insulation board is attached to a portion of the metal drum. The coil is disposed below the insulation board. The metal drum heats up coffee beans. AC power is supplied to the coil to enable the coil to produce an AC magnetic field. The metal drum is heated up by electromagnetic induction to thereby heat up the coffee beans in the metal drum.

Preferably, the coffee bean roaster further comprises a cooling fan disposed below the coil and adapted to cool down the insulation board.

The insulation board is a curved glass panel, and the coil has a curved surface in its entirety to correspond in shape to the insulation board.

The coffee bean roaster further comprises a coil holder. The coil is disposed on the coil holder, for example, by being adhered to the coil holder or inserted into the coil holder. In the latter scenario, the coil holder has a groove whereby the coil is inserted into the coil holder.

The coffee bean roaster further comprises a filtering mesh fitted snugly to one end of the metal drum. The coffee bean roaster further comprises a circulating fan and a pipeline channel, both of which are disposed beside the filtering mesh, with the pipeline channel connected to the filtering mesh, such that the air current generated by the circulating fan passes through the pipeline channel and the filtering mesh before being admitted into the metal drum.

The coffee bean roaster further comprises a tripartite pipe and an ash pipe. The tripartite pipe has three ends, one being a coffee bean inlet, another communicating with the metal drum, and the other communicating with the ash pipe.

The coffee bean roaster further comprises a control panel and a coffee bean container. The control panel is disposed between the tripartite pipe and the metal drum. The control panel covers the other end of the metal drum. The control panel further comprises a coffee bean outlet. The coffee bean container is disposed in front of the control panel and adapted to contain coffee beans roasted and discharged from the coffee bean outlet. The coffee bean container further comprises a cooling fan. The cooling fan cools down the roasted coffee beans.

### BRIEF DESCRIPTION OF THE DRAWINGS

FIG. 1 is a perspective view of a coffee bean roaster of the present invention;

FIG. 2 is an exploded view of the coffee bean roaster of the present invention;

FIG. 3 is a cutaway diagram of the coffee bean roaster of the present invention;

FIG. 4 is a cutaway diagram of the coffee bean roaster taken from another angle according to the present invention; and

FIG. 5 is a schematic view of the coffee bean roaster of the present invention, showing a coil of its insulation board.

### DETAILED DESCRIPTION OF THE EMBODIMENTS

The present invention is hereunder illustrated with preferred embodiments to enable persons skilled in the art to gain insight into the present invention.

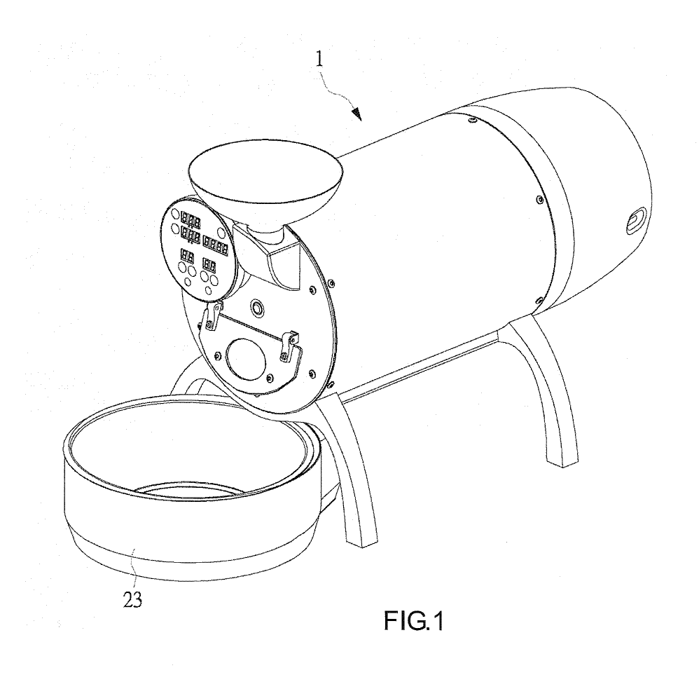

Referring to FIG. 1, the present invention provides a coffee bean roaster 1 which comprises a coffee bean container 23 for holding roasted coffee beans.

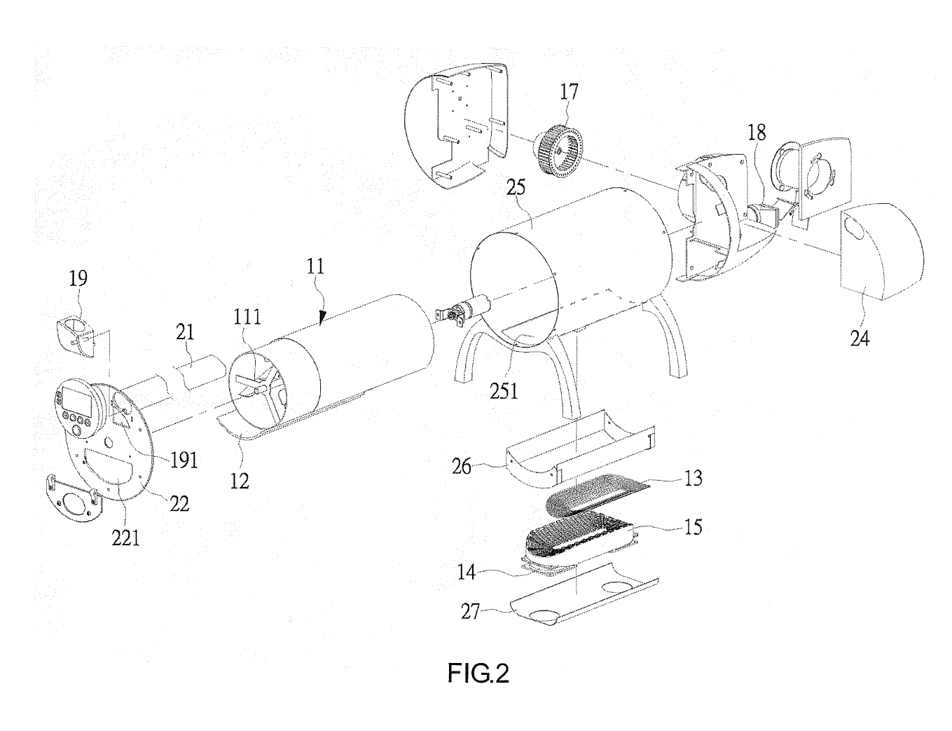

Referring to FIG. 2, the coffee bean roaster 1 of the present invention comprises a metal drum 11, an insulation board 12, and a coil 13. The insulation board 12 is attached to a portion of the metal drum 11. The coil 13, such as a copper coil, provides a heat source by electromagnetic induction. The coil 13 is disposed below the insulation board 12. The coil 13 is powered by alternating current (AC) to produce an AC magnetic field. The metal drum 11 is heated up by electromagnetic induction to thereby heat up and roast the coffee beans in the metal drum 11. To match the metal drum 11 in shape, the insulation board 12 is a curved glass panel, and the coil 13 has a curved surface in its entirety to correspond in shape to the insulation board 12; however, the present invention is not limited thereto. In another embodiment, the metal drum 11 is of another shape, both the insulation board 12 and the coil 13 each have an appropriate shape.

The coil 13 produces the AC magnetic field (with a frequency of 20 kHz to 27 kHz). When the AC magnetic field is applied to the metal drum 11 above the insulation board 12, a portion of the metal drum 11 is positioned proximate to the insulation board 12 and generates induction eddy current under the AC magnetic field produced by the coil 13. Inside the metal drum 11, the eddy current is stopped (to the extent which depends on the physical properties of the material which the metal drum is made of) and converted into thermal energy. Therefore, the larger the resistance of the metal drum 11 is, the more the thermal energy is available.

Preferably, the coffee bean roaster 1 further comprises a cooling fan 14 disposed below the coil 13. With the insulation board 12 being attached to the metal drum 11, the metal drum 11 produces induction eddy current and thereby generates heat to reach a high temperature. In view of this, the cooling fan 14 serves to cool down the insulation board 12. The quantity of the cooling fans 14 is subject to changes as needed.

The coffee bean roaster 1 further comprises a coil holder 15. The coil 13 is disposed on the coil holder 15, for example, by being adhered to the coil holder 15 or inserted into the coil holder 15. In the latter scenario, the coil holder 15 has a groove whereby the coil 13 is inserted into the coil holder 15.

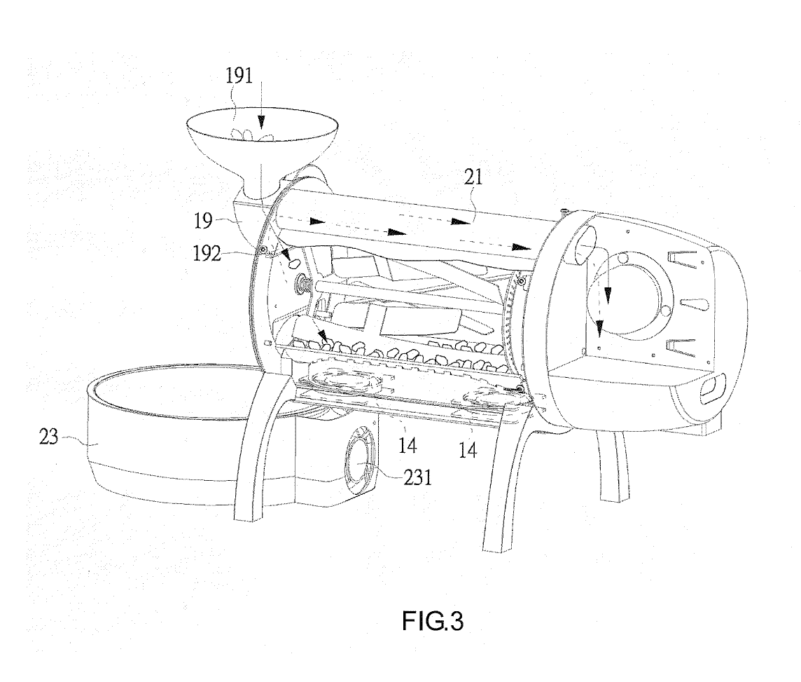

Referring to FIG. 3, the coffee bean roaster 1 further comprises a tripartite pipe 19 and an ash pipe 21. The tripartite pipe 19 has three ends, one being a coffee bean inlet 191, another being a coffee bean outlet 192 in communication with the metal drum 11, and the other communicating with the ash pipe 21. Coffee beans are fed into the coffee bean inlet 191 and then conveyed to the metal drum 11 through the coffee bean outlet 192 (in the direction indicated by solid line.) By contrast, lightweight coffee bean skin or ash drifts away from the coffee bean inlet 191 to eventually reach the ash pipe 21.

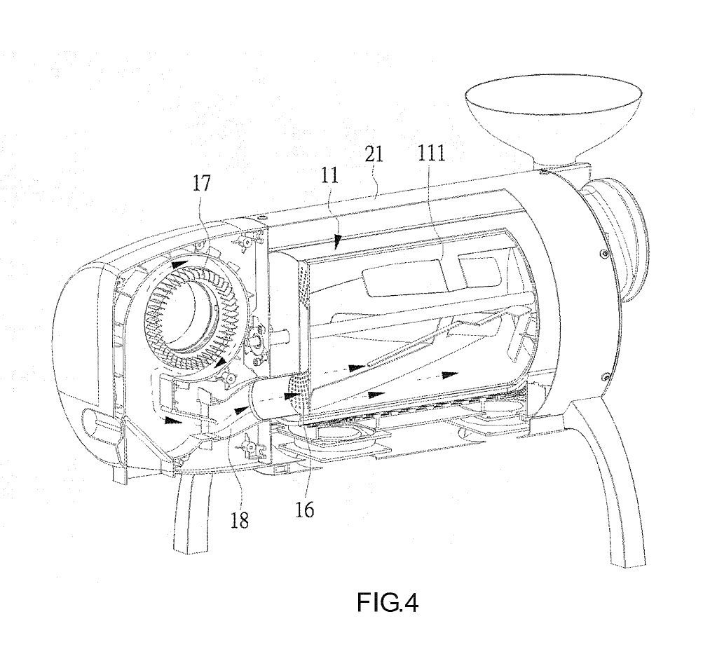

Referring to FIG. 3 and FIG. 4, the coffee bean roaster 1 further comprises a filtering mesh 16. The filtering mesh 16 is fitted snugly to one end of the metal drum 11. The coffee bean roaster 1 further comprises a control panel 22. The control panel 22 covers the other end of the metal drum 11.

The coffee bean roaster 1 further comprises a circulating fan 17 and a pipeline channel 18, both of which are disposed beside the filtering mesh 16. The pipeline channel 18 is connected to the filtering mesh 16. When the circulating fan 17 is on, air current goes (in the direction indicated by dashed line) to thereby pass through the pipeline channel 18 and the filtering mesh 16 so as to be admitted into the metal drum 11.

Since the metal drum 11 is heated up by electromagnetic induction, the hot air inside the metal drum 11 rises such that vanes 111 inside the metal drum 11 rotate to thereby blend the coffee beans therein. As the hot air inside the metal drum 11 rises, as mentioned before, lightweight coffee bean skin or ash drifts away from the coffee bean inlet 191, and then travels along the ash pipe 21 (in the direction indicated by the arrowed dashed lines) to eventually reach a dust collecting chamber 24 (shown in FIG. 2), so as to be handled by a user.

Referring to FIG. 2 and FIG. 3, the control panel 22 further comprises a coffee bean outlet 221. The coffee bean container 23 is disposed in front of the control panel 22 and adapted to contain coffee beans roasted and discharged from the coffee bean outlet 221. The coffee bean container 23 further comprises a cooling fan 231. The cooling fan 231 cools down the roasted coffee beans.

To prevent the user from burn injury, the metal drum 11 is enclosed by a casing 25. An opening 251 is disposed at the bottom of the casing 25 to allow the metal drum 11 to be heated up by electromagnetic induction as soon as the AC magnetic field produced by the coil 13 is applied to the metal drum 11. A frame 26 and a baseboard 27 are disposed below the casing 25 to fix thereto the coil 13, the cooling fan 14, and the coil holder 15.

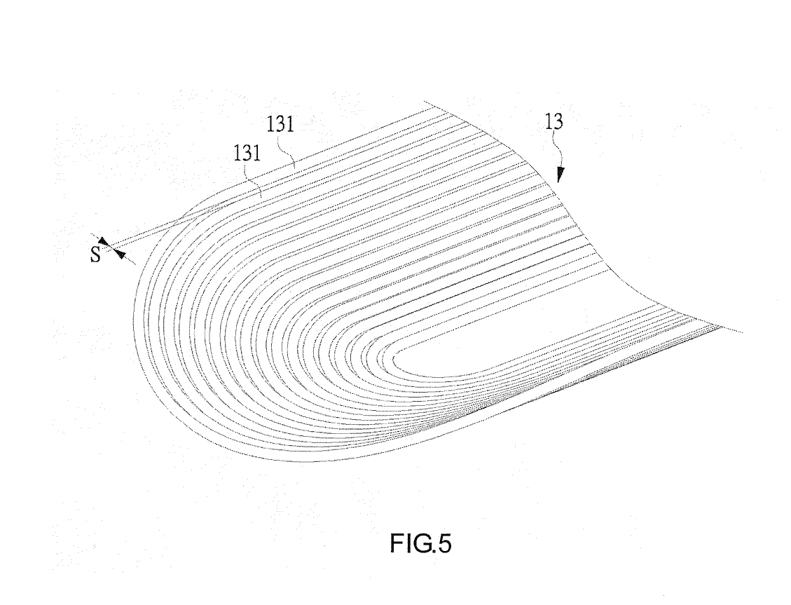

Referring to FIG. 5, to cool down the insulation board 12 efficiently, the coil 13 comprises a plurality of metal wires 131, such as copper wires, with every two adjacent metal wires 131 spaced apart by a space S. The width of the space S ranges from 0.5 mm to 1 mm, and preferably equals 0.9 mm. Air current generated by the cooling fan 14 passes through the space S such that the insulation board 12 is cooled down efficiently.

In conclusion, the present invention differs from the prior art in objectives, means, advantages, and features. The above embodiments are provided for illustrative sake. The scope of the present invention is defined by the appended claims rather than restricted to the above embodiments.

What is claimed is:

1. A coffee bean roaster, comprising:
a metal drum for heating coffee beans;
an insulation board attached to a portion of the metal drum; and
a coil disposed below the insulation board, wherein AC power is supplied to the coil to enable the coil to produce an AC magnetic field, and the metal drum is heated up by electromagnetic induction.

2. The coffee bean roaster of claim 1, further comprising a cooling fan disposed below the coil and adapted to cool down the insulation board.

3. The coffee bean roaster of claim 1, wherein the insulation board is a curved glass panel, and the coil has a curved surface in its entirety to correspond in shape to the insulation board.

4. The coffee bean roaster of claim 3, further comprising a coil holder which the coil is disposed on.

5. The coffee bean roaster of claim 4, wherein the coil is adhered to the coil holder.

6. The coffee bean roaster of claim 4, wherein the coil is inserted into the coil holder.

7. The coffee bean roaster of claim 1, further comprising a filtering mesh fitted snugly to an end of the metal drum.

8. The coffee bean roaster of claim 7, further comprising a circulating fan and a pipeline channel, both being disposed beside the filtering mesh, and the pipeline channel being connected to the filtering mesh such that air current generated from the circulating fan is admitted into the metal drum through the filtering mesh.

9. The coffee bean roaster of claim 1, further comprising a tripartite pipe and an ash pipe, wherein the tripartite pipe has three ends, one being a coffee bean inlet, another communicating with the metal drum, and the other communicating with the ash pipe.

10. The coffee bean roaster of claim 2, wherein the coil comprises a plurality of metal wires, every two adjacent metal wires being spaced apart by a space of a width of 0.5 mm to 1 mm to thereby allow air current generated from the cooling fan to pass through the space, thereby cooling down the insulation board efficiently.
